(19) United States
(12) Patent Application Publication
(10) Pub. No.: US 2011/0308337 A1
(43) Pub. Date: Dec. 22, 2011

(54) Centrifugal energy generator

(76) Inventor: THINH Duc Nguyen, St. Laurent (CA)

(21) Appl. No.: 12/803,059

(22) Filed: Jun. 18, 2010

(51) Int. Cl. F16H 33/00

(52) U.S. Cl. 74/61

(57) ABSTRACT

Two machines, one linear type and one rotative type, rotate some eccentric masses to generate the centrifugal forces, then guide these centrifugal forces into a direction, linear or circular, to extract energy.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to devices producing energy by using the centrifugal force. The centrifugal force is guided to a linear displacement or a circular displacement.

2. Description of the Prior Art

The Moller patent (U.S. Pat. No. 3,960,036) disclosed a torque converter using the centrifugal forces of some rotating masses to rotate an output shaft.

The Makarov patent (U.S. Pat. No. 4,498,357) disclosed a power converter unit using the centrifugal forces of some rotating masses to rotate an output shaft.

### BRIEF SUMMARY OF THE INVENTION

The present invention discloses two types of device to extract energy from the centrifugal forces generated by the rotation of some rotors.

The linear device guides the centrifugal forces to work in a linear movement.

The rotative device guides the centrifugal forces to work in a circular movement.

### BRIEF DESCRIPTION OF THE SEVERAL VIEWS OF THE DRAWING

FIG. 1 is the top view of a typical eccentric rotor R.

FIG. 2 is a side view of a typical eccentric rotor R.

FIG. 3 is the top view of a typical pulley 26.

FIG. 4 is the section view 4-4 of the pulley 26.

FIG. 5 is the diagram of the centrifugal forces.

FIG. 6 is a perspective view of a typical sliding plate.

FIG. 7 is a perspective view of the sliding plate SP-1 with its components.

FIG. 8 is the front view of a typical output transmission shaft 31.

FIG. 9 is the front view of a typical input shaft 32.

FIG. 10 is the front view of the output shaft 33.

FIG. 11 is a perspective view of a typical geared clutch bearing 34.

FIG. 12 is a perspective view of the sliding plate SP-1 with its mechanism.

FIG. 13 is front view of a typical reversing gear 41.

FIG. 14 is a perspective view of a typical attach bar 42.

FIG. 15 is a perspective view of 4 sliding plates with their mechanism.

FIG. 16 is a side view of the linear device.

FIG. 17 is a side view of the linear device.

FIG. 18 is a top view of the sliding plate SP-1.

FIG. 19 is a top view of the sliding plate SP-2.

FIG. 20 is a top view of the sliding plate SP-3.

FIG. 21 is a top view of the sliding plate SP-4.

FIG. 22 is a perspective view of the linear device.

FIG. 23 is the front view of a typical double pulley 84.

FIG. 24 is a section view of the double pulley 84.

FIG. 25 is a view of the main output shaft 85.

FIG. 26 is a view of the secondary output shaft 86.

FIG. 27 is a view of the center shaft 87.

FIG. 28 is a perspective view of a typical rotating disk 80.

FIG. 29 is a perspective view of the first rotating disk 80-1 with its components and the related mechanism.

FIG. 30 is a perspective view of the second rotating disk 80-2 with its components and the related mechanism.

FIG. 31 is the top view of the rotative device without the frame.

FIG. 32 is a perspective view of the rotative device.

FIG. 33 is another perspective view of the rotative device.

### DETAILED DESCRIPTION OF THE INVENTION

In order to be able to generate energy, the centrifugal force is guided to a determined direction. In the present invention, one linear type device and one rotative type device are described.

Paragraph [0009] to paragraph [0032] describes the linear type device. Paragraph [0033] to paragraph [0041] describes the rotative type device.

By rotating a mass eccentrically, a centrifugal force is generated. In FIG. 5: 2 identical eccentric rotors R-R and R-L are positioned and oriented symmetrically by the axis Y and rotate at the same rotation speed W but in reverse direction, clockwise and counter-clockwise.

A centrifugal force F-1 is generated for the rotor R-R, and a centrifugal force F-2 is generated for the rotor R-L. The force F-total is the sum of the force F-1 and F-2.

Because the position and the rotation speed of the two eccentric rotors R-R and R-L are symmetrical by the axis Y, the force F-total is always parallel to axis Y and proportional to the sinus of the force [F-1+F-2].

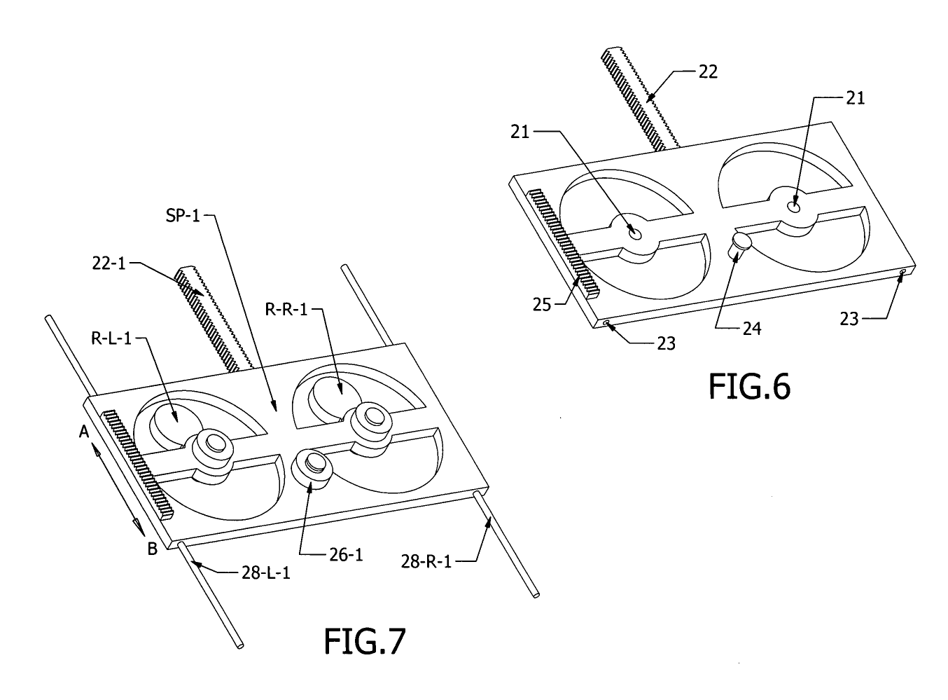

To guide the centrifugal forces of the eccentric rotors R-R and R-L, a sliding plate in FIG. 6 is designed. The linear device may use many sliding plates. In the present invention, a linear device using 4 sliding plates is described.

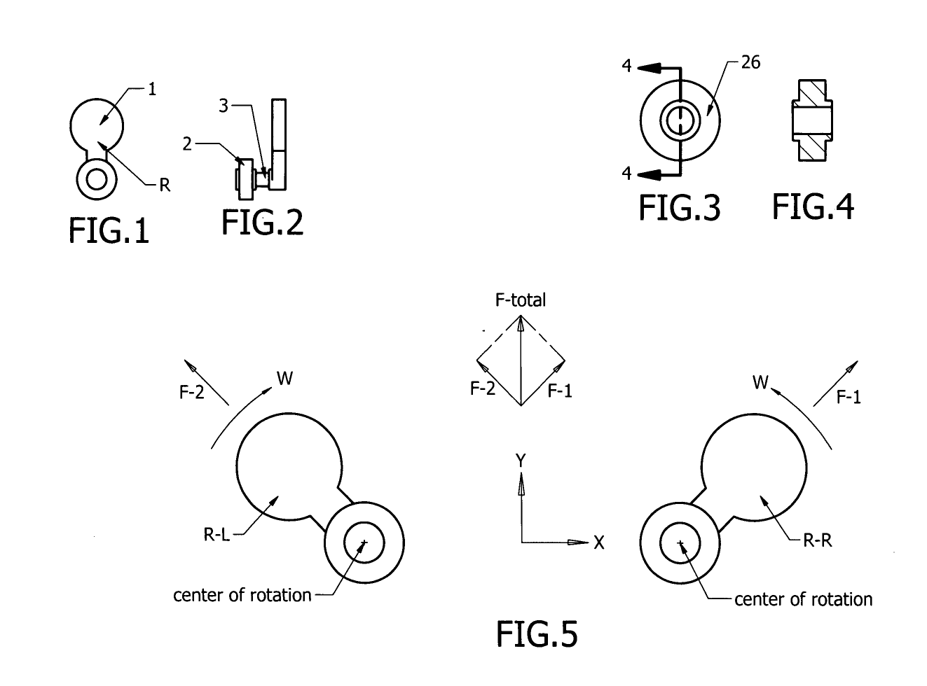

The eccentric rotor R in FIG. 1 has an eccentric mass 1, a pulley 2 and a rotating rod 3 in FIG. 2.

In FIG. 6, a typical sliding plate has 2 holes 21 to fit 2 eccentric rotors R, a round post 24 to fit a pulley 26 shown in FIG. 3, an output gear rack 22, 2 through holes 23 to fit 2 guiding rods 28-R-1 and 28-R-2 shown in FIG. 7, a reversing gear rack 25. The reversing gear rack is mounted on top face of the sliding plates SP-1 and SP-3, on the bottom face of the sliding plates SP-2 and SP-4.

FIG. 7 shows the sliding plate SP-1 with its 2 eccentric rotors R-R-1 and R-R-2, pulley 26-1, 2 guiding rods 28-R-1 and 28-L-1. When the 2 rotors R-R-1 and R-L-1 rotates by the way described in FIG. 5, the sliding plate SP-1 moves in both directions A-B and B-A parallel to the 2 guiding rods 28-R-1 and 28-L-1.

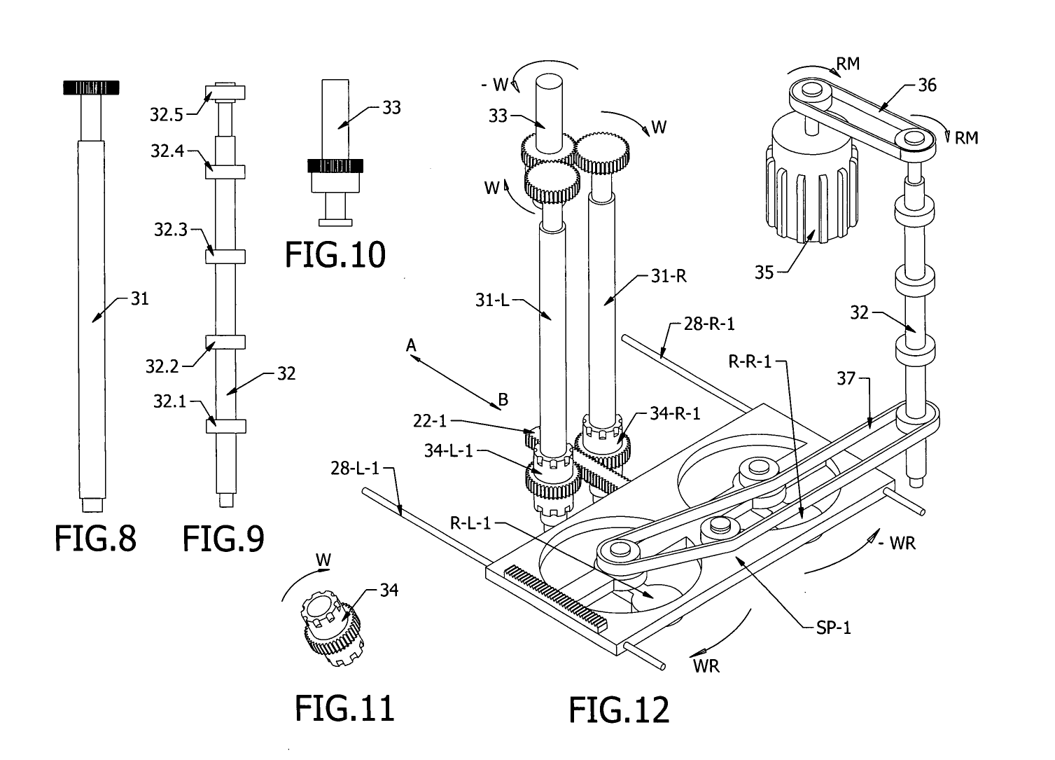

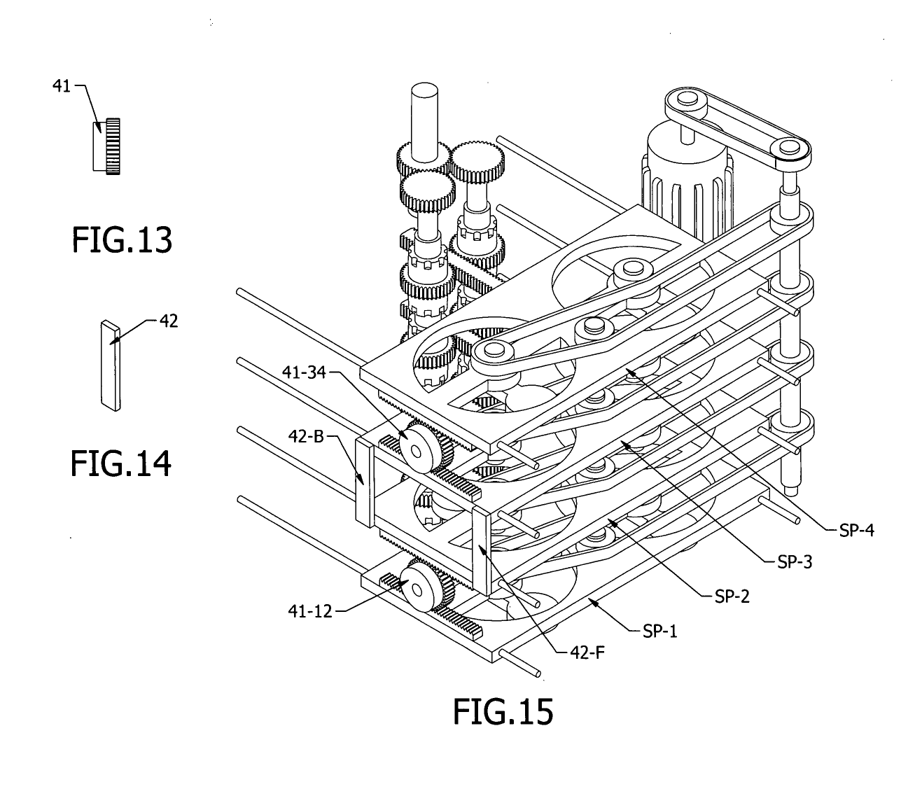

FIG. 8 represents a typical output transmission shaft 31 which has a gear on top.

FIG. 9 represents the input shaft 32 which has 4 pulleys 32.1,32.2,32.3, 32.4 having the same diameter, and a pulley 32.5. The 4 pulleys 32.1,32.2,32.3, 32.4, with their respective belt, are used to rotate the eccentric rotors on the sliding plates SP-1,SP-2,SP-3,SP-4 shown in FIG. 15.

FIG. 10 represents the output shaft 33.

FIG. 11 represents a typical geared clutch bearing 34. When the geared clutch bearing 34 rotates in direction W, it locks onto the output transmission shaft 31 and rotates the output transmission shaft 31. When the geared clutch bearing rotates in reverse direction −W, it acts as a normal bearing.

In FIG. 12, the frame of the linear device is omitted for clarity. An electrical motor 35 rotates the input shaft 32 by the belt 36 in direction RM. The input shaft 32 rotates the eccentric rotors, R-R-1,R-L-1 of the sliding plate SP-1, by the belt 37. With the mounting of the belt 37, the eccentric rotor R-L-1 rotates at speed WR, and the eccentric rotor R-R-1 rotates at the same speed but in reverse in direction −WR. The sliding plates SP-1 moves in direction A-B, B-A, by the centrifugal forces of the eccentric rotors R-R-1, R-L-1, accordingly to the diagram in FIG. 5. The belt 37 is an extensible belt.

When the sliding plate SP-1 moves in direction B-A, the output gear rack 22-1 rotates the geared clutch bearing 34-R-1, the geared clutch bearing 34-R-1 rotates the output transmission shaft 31-R in direction W, the output transmission shaft 31-R rotates the output shaft 33 in direction −W. The geared clutch bearing 34-L-1 acts as a normal bearing.

When the sliding plate SP-1 moves in direction A-B, the output gear rack 22-1 rotates the geared clutch bearing 34-L-1, the geared clutch bearing 34-L-1 rotates the output transmission shaft 31-L in direction W, the output transmission shaft 31-L rotates the output shaft 33 in direction −W. The geared clutch bearing 34-R-1 acts as a normal bearing.

The same mechanism for sliding plate SP-1 is applied for sliding plates SP-2,SP-3,SP-4. The position of the sliding plates is shown in FIG. 15. All the 4 sliding plates drive (rotate) the output shaft 33 in one direction all the time.

In order to reduce the vibration generated by the movements of the sliding plates, the movements of the sliding plates are synchronized as below:
The movement of the sliding plate SP-1 is the same movement of the sliding plate SP-4.
The movement of the sliding plate SP-2 is the same movement of the sliding plate SP-3.
The sliding plates SP-1 and SP-4 move in reverse direction of the sliding plates SP-2 and SP-3.

In FIG. 15, the sliding plate SP-2 is attached to the sliding plate SP-3 by the attach bars 42-F and 42-B shown in FIG. 14. The sliding plate SP-2 moves the same way as the sliding plate SP-3.

The movement of the sliding plate SP-1 is opposite to the movement of the sliding plate SP-2 by the reversing gear 41-12. The movement of the sliding plate SP-4 is opposite to the movement of the sliding plate SP-3 by the reversing gear 41-34. Because the sliding plates SP-2 and SP-3 are attached together, the sliding plate SP-1 moves the same way as the sliding plate SP-4, and in opposite direction to the sliding plates SP-2 and SP-3.

In FIG. 17, as the reversing gears 41-12 and 41-34 fixed to the frame of the device, when the sliding plates SP-1 and SP-4 move in direction V, the sliding plates SP-2 and SP-3 move in direction −V.

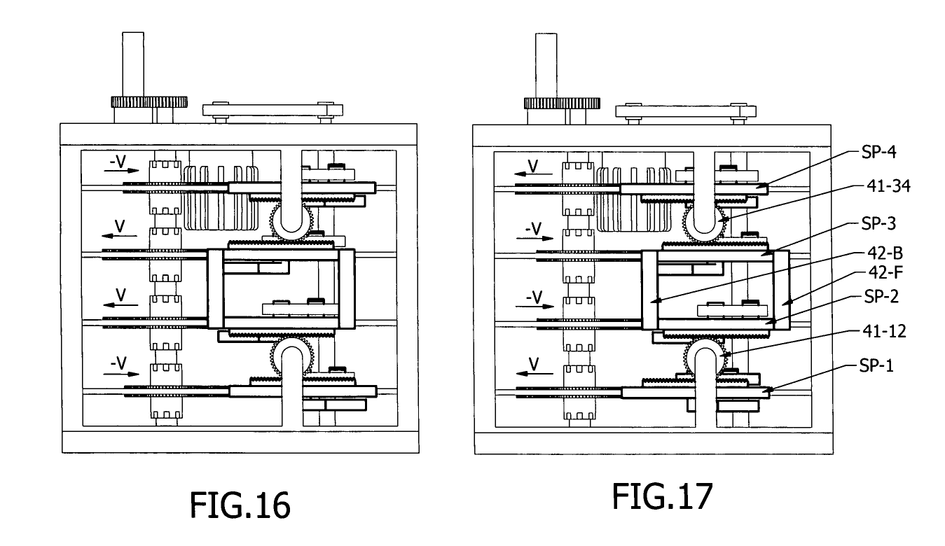

In FIG. 16, when the sliding plates SP-1 and SP-4 move in direction −V, the sliding plates SP-2 and SP-3 move in direction V. Because the 4 sliding plates have the same weight, they slide without vibration.

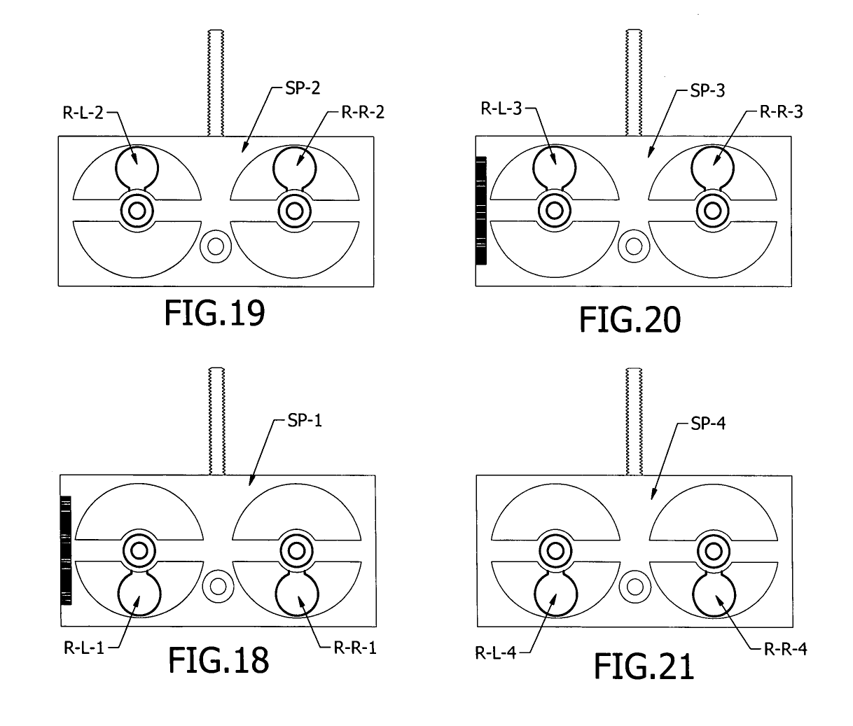

To balance the movement of the eccentric rotors, the eccentric rotors of the sliding plates have to be in a balancing orientation. The FIG. 18, FIG. 19, FIG. 20, FIG. 21 show the orientations of the rotors of the sliding plates at a certain moment. The orientation of the rotors R-R-1 and R-L-1 of the sliding plate SP-1 is the same as the orientation of the rotors R-R-4 and R-L-4 of the sliding plate SP-4. The orientation of the rotors R-R-2 and R-L-2 of the sliding plate SP-2 is the same as the orientation of the rotors R-R-3 and R-L-3 of the sliding plate SP-3. The orientation of the rotors of the sliding plates SP-2 and SP-3 are 180 degrees off-phased from the orientation of the rotors of the sliding plates SP-1 and SP-4. In this configuration, the movements of the eccentric rotors of the 4 sliding plates are balanced.

Because the sliding plates SP-2 and SP-3 have the same position, the same speed, the same acceleration, they can be combined to form a single equivalent sliding plate.

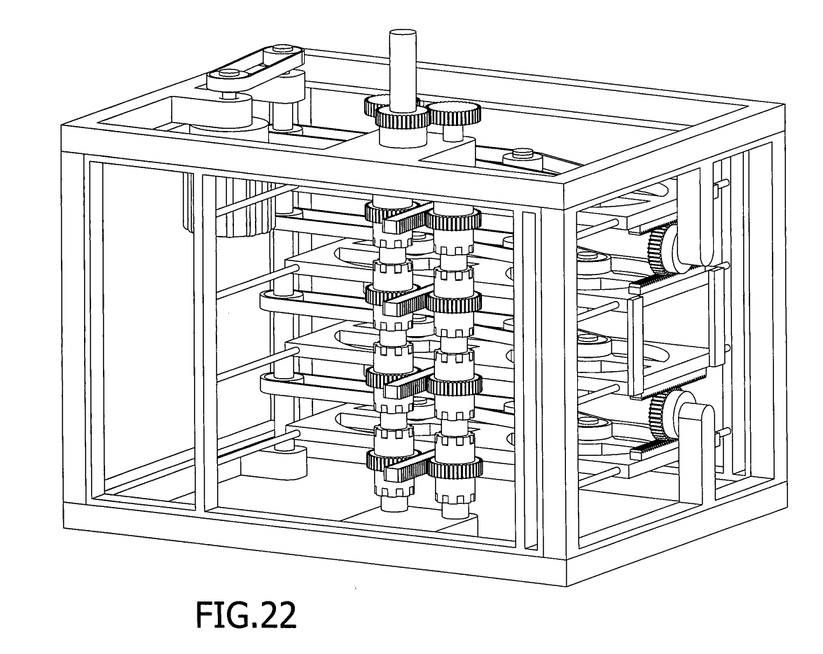

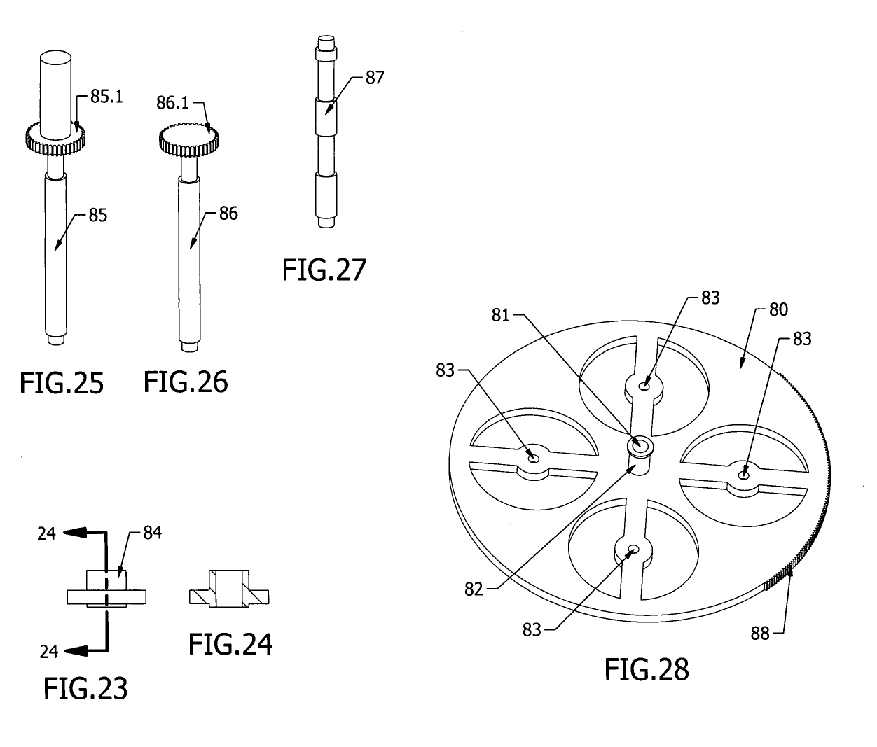

The FIG. 22 shows the complete linear device.

The energy generated by the centrifugal forces of the rotors is transmitted to the sliding plates. This energy can be used directly from the vibration of the sliding plates by using some kind of linear transformation of energy.

In the rotative device, some rotating disks shown in FIG. 28 are used to support the eccentric rotors and transmit the centrifugal energy generated to the main output shaft 85.

The rotative device may have plural rotating disks. In this invention, a rotative device with 2 rotating disks is described.

In FIG. 28, a typical rotating disk 80 is shown. The rotating disk can have plural holes 83 to support the same amount of eccentric rotors. In this invention, a rotating disk with 4 holes 83 is described. A double pulley 84 is mounted on the round sleeve 82 and the rotating disk rotates around the center shaft 87 through the hole 81. The double pulley 84 rotates independently to the rotating disk.

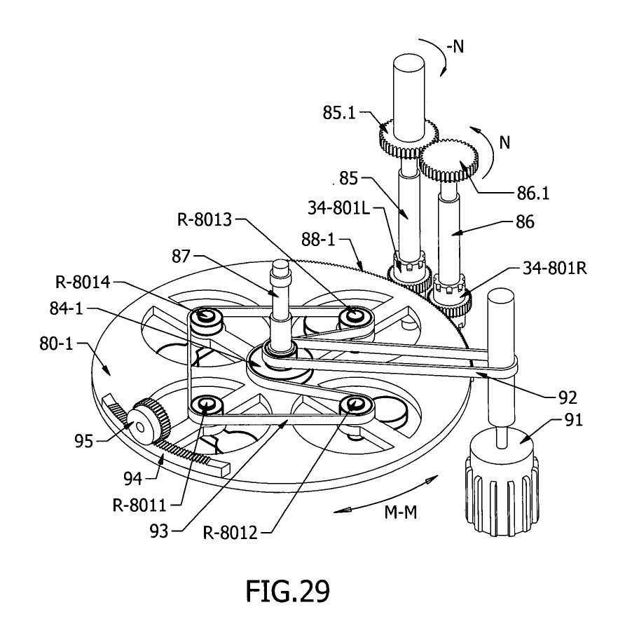

In FIG. 29, the mechanism for the rotating disk 80-1 is shown. The electrical motor 91 drives the double pulley 84-1 by the belt 92. The double pulley 84-1 drives the 4 eccentric rotors R-8011, R-8012, R-8013,R-8014 by the belt 93. The 4 eccentric rotors rotate in the same direction at the same speed.

The centrifugal forces of the eccentric rotors on the rotating disk 80-1 vibrate the rotating disk 80-1 around the center shaft 87 in direction M-M. By the geared clutch bearings 34-801R and 34-801L (uni-direction bearing), the vibration of the rotating disk 80-1 rotates the main output shaft 85 in direction −N and the secondary output shaft 86 in direction N for the full cycle of vibration. Because the main output shaft 85 is geared to the secondary output shaft 86 by the gear 85.1 and the gear 86.1, the rotating disk 80-1 drives (rotates) the main output shaft 85 in one direction all the time.

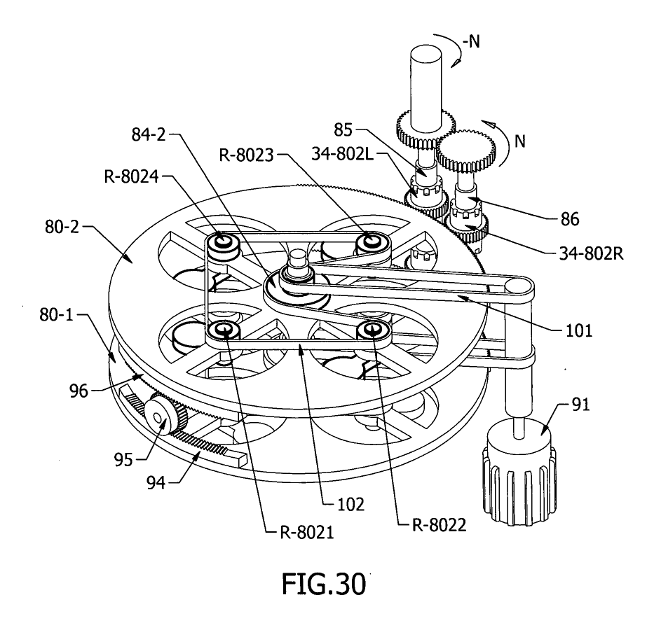

In FIG. 30, the gear rack 94 is attached to the rotating disk 80-1 and the gear rack 96 is attached to the rotating disk 80-2. A reversing gear 95 is used to synchronize the movement of the rotating disk 80-1 and the movement of rotating disk 80-2.

FIG. 30 shows the mechanism for the rotating disk 80-2. The electrical motor 91 drives the double pulley 84-2 by the belt 101. The double pulley 84-2 drives the 4 eccentric rotors R-8021, R-8022, R-8023, R-8024 by the belt 102. All the 8 eccentric rotors of the 2 rotating disks 80-1 and 80-2 rotate in the same direction at the same speed. Like the rotating disk 80-1, the vibration of the rotating disk 80-2 drives the main output shaft 85 in direction −N, all the time, by the geared clutch bearing 34-802R and 34-802L.

With the reversing gear 95 fixed to the frame of the rotative device and the gear racks 94 and 96, the movement of the rotating disk 80-1 is the reverse movement of the rotating disk 80-2. The movements of the 2 rotating disks are balanced.

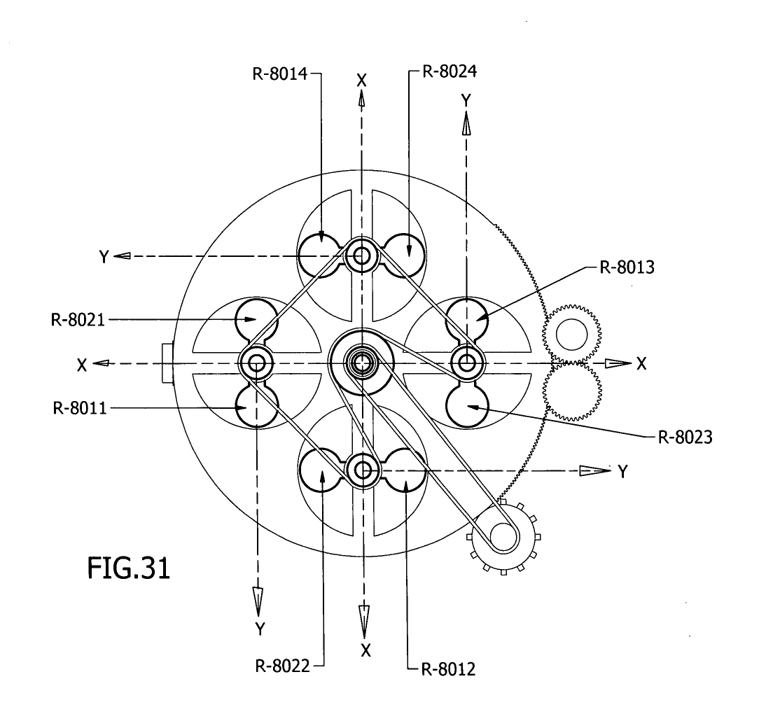

FIG. 31 shows the orientations of the eccentric rotors at a certain moment. The 4 rotors R-8011, R8012, R8013, R-8014 of the rotating disk 80-1 are at the same orientation to the local references X-Y. The 4 rotors R-8021, R-8022, R-8023, R-8024 of the rotating disk 80-2 are at the same orientation to the local references X-Y. The rotors of the rotating disk 80-1 are at 180 degrees off phase with the rotors of the rotative disk 80-2. The sum of the centrifugal forces of all the eccentric rotors on a rotating disk is only a moment to rotate the rotating disk. The movements of the 8 rotors are balanced.

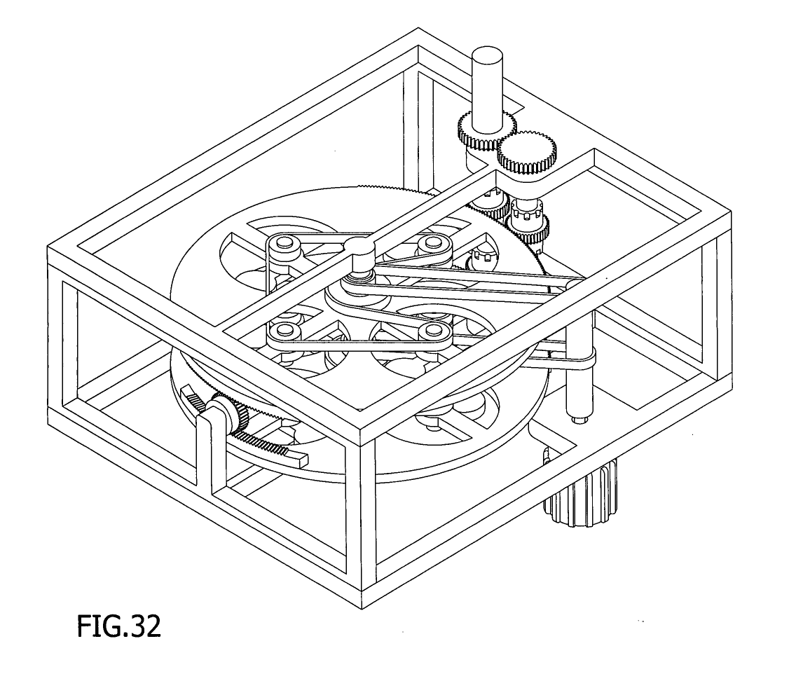

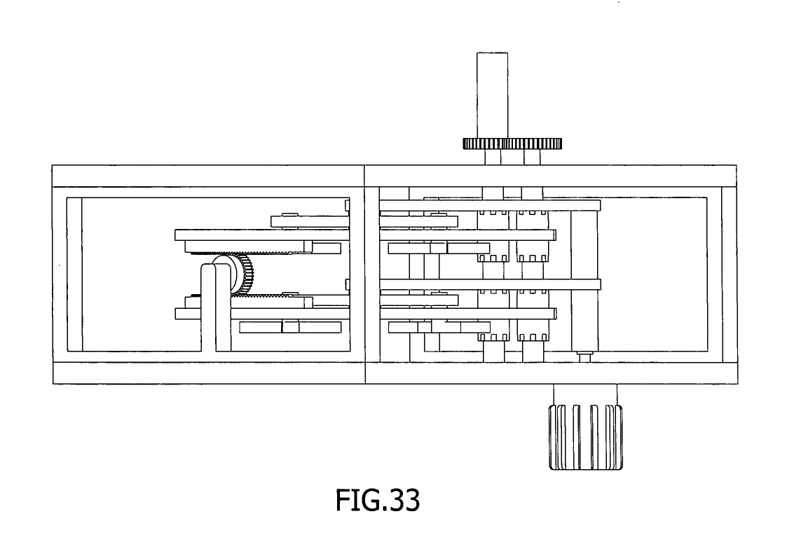

FIG. 32 and FIG. 33 show the complete rotative device at different views.

In the linear device, the energy generated by the centrifugal forces of the rotors is transmitted to the output shaft 33. In the rotative device, the energy generated by the centrifugal forces of the rotors is transmitted to the main output shaft 85.

If the mechanism of both the linear device and the rotative device is frictionless, the output energy generated by the centrifugal forces of the rotors is bigger than the energy input to the electrical motor. These devices produce a net output energy which is the difference of the energy generated by the centrifugal forces of the rotors and the electrical input energy to the motor.

For the linear device, the ratio of [output energy/input energy] can be modified by changing the ratio of [the mass of the sliding plate/the mass of the eccentric rotors per sliding plate].

For the rotative device, the ratio of [output energy/input energy] can be modified by changing the ratio of [the moment of inertia of the rotating disk/the mass of the eccentric rotors per rotating disk].

The energy generated by the centrifugal forces of the rotors is transmitted to the rotating disks. This energy can be used directly from the vibration of the rotating disks by using some kind of rotative transformation of energy.

What is claimed is:

1. A linear centrifugal energy generator comprising:
a stack of a plurality of parallel unidirectional sliding plates, each of which has a planar unidirectional sliding guide system and two eccentric rotors rotating symmetrically to their middle line parallel to the sliding direction;
a driving system to rotate all the said eccentric rotors of all the said sliding plates at the same speed of rotation and with the appropriate direction of rotation for each rotor, the said driving system having a motor rotating an input shaft, the said input shaft having a stack of pulleys, one pulley for each said sliding plate, the said pulleys pulling double sided belts which rotate the said eccentric rotors.

2. A machine of claim 1 includes a movement converter mechanism converting continuously the oscillations of the said sliding plates into a unidirectional rotative movement by using double side gear racks mounted on the said sliding plates, one double side gear rack for each sliding plate, the said double side gear racks rotating the geared clutch bearings located on both side of the said double side gear racks, the said geared clutch bearings rotating two transmission shafts (one shaft per side of the said double side gear racks) concentric to the said geared clutch bearings in the same direction, the said two transmission shafts being geared to an output shaft.

3. A machine of claim 1 includes a movement converter mechanism converting continuously the oscillations of the said sliding plates into a rotative movement by using a system of cranks and crankshaft.

4. A machine of claim 1, wherein the said sliding plates are organized into groups of four stacked parallel synchronized sliding plates to eliminate the vibration, the bottom sliding plate and the top sliding plate moving together, the two middle sliding plates moving together, the said two middle sliding plates moving in reverse direction and at the same speed to the said bottom and top sliding plates by a reversing mechanism using gear racks mounted on the sliding plates and pinions or by a reversing mechanism using belts and pulleys, the orientation of the said eccentric rotors of the top and bottom sliding plates being set at 180 degrees off phase from the orientation of the said eccentric rotors of the two middle sliding plates, the said two middle sliding plates can be combined to form an equivalent single double size sliding plate.

5. A rotative centrifugal energy generator comprising:
a center shaft centering a stack of a plurality of rotating disks, each of which has a plurality of eccentric rotors whose the centers of rotation are circularly equidistantly spaced around the center of the said center shaft, the axes of rotation of the said eccentric rotors are parallel to the axis of the said center shaft, the said eccentric rotors rotate at the same speed and the same direction, the said eccentric rotors of a rotating disk have the same relative orientation to the radiuses of the said rotating disk passing by the centers of rotation of the said eccentric rotors so that the sum of the centrifugal forces generated by the eccentric rotors is only a moment for rotation;
an off-center driving system to rotate all eccentric rotors off all rotating disks at the same speed and the same direction, this off-center driving system has a motor placed outside of the rotating disks, this motor rotating by belts the double pulleys concentric to the rotating disks, these double pulleys rotating by belts the eccentric rotors.

6. A machine of claim 5 includes a movement converter mechanism converting continuously the oscillations of the said rotating disks into a unidirectional rotative movement, the said movement converter mechanism using geared rotating disk coupled to two geared clutch bearings, one geared clutch bearing for clockwise rotation and one geared clutch bearing for counter-clockwise rotation, the said two geared clutch bearings rotating two output shafts in both direction, the said two output shafts are geared together.

7. A machine of claim 5, wherein the said rotating disks are organized into groups of two synchronized rotating disks to eliminate the vibration, the rotation of the first rotating disk being reversed to the rotation of the second rotating disk by using gear racks and pinion, the orientation of the eccentric rotors of the first rotating disk being set at 180 degrees off phase to the orientation of the eccentric rotors of the second rotating disk.
